(19) United States
(12) Patent Application Publication
(10) Pub. No.: US 2015/0312380 A1
(43) Pub. Date: Oct. 29, 2015

(54) TRANSLATING CELLULAR PROTOCOLS FOR A VEHICLE TELEMATICS UNIT

(71) Applicant: General Motors LLC, Detroit, MI (US)

(72) Inventors: Steven Sauerbrey, Farmington Hills, MI (US); Scott Droste, Ferndale, MI (US); Andrew Macdonald, Grosse Pointe Park, MI (US); Abuzafor Rasal, Hamtramck, MI (US)

(73) Assignee: General Motors LLC, Detroit, MI (US)

(21) Appl. No.: 14/264,862

(22) Filed: Apr. 29, 2014

(51) Int. Cl. H04L 29/06

(52) U.S. Cl. CPC H04L 69/08; H04L 69/18; H04W 88/16

(57) ABSTRACT

A system and method of converting a cellular protocol of wireless communications at a vehicle includes receiving, at a relay device located in a vehicle, wireless communications that are sent from a vehicle telematics unit using a first cellular protocol; converting the wireless communications to a second cellular protocol at the relay device; and transmitting the converted wireless communications from the relay device to a cell tower using the second cellular protocol.

### TECHNICAL FIELD

The present invention relates to wireless communications and, more specifically, to translating communications from one cellular protocol to another cellular protocol.

### BACKGROUND

Vehicles commonly carry telematics units that monitor vehicle functions and also facilitate wireless communications. The vehicle telematics units can wirelessly communicate voice and data using cellular protocols and have been installed on vehicles for a number of years. As cellular technology has evolved, the cellular protocols used by vehicle telematics units and other handheld cellular phones have become increasingly sophisticated and each evolution of cellular technology can be identified by a different cellular protocol. As time passes, wireless carriers may phase out service to vehicle telematics units and wireless devices communicating using older cellular protocols. The phase out of service may not be noticed by users of handheld cellular phones as they may be replaced with devices using newer cellular protocols before such a phase out occurs. However, the life expectancy of vehicles and the vehicle telematics units installed on those vehicles can outlast the handheld cellular phones. As vehicle telematics units age, they may no longer be able to wirelessly communicate using an older cellular protocol that has been rendered obsolete by subsequent cellular protocols.

### SUMMARY

According to an embodiment, there is provided a method of converting a cellular protocol of wireless communications at a vehicle. The method includes receiving, at a relay device located in a vehicle, wireless communications that are sent from a vehicle telematics unit using a first cellular protocol; converting the wireless communications to a second cellular protocol at the relay device; and transmitting the converted wireless communications from the relay device to a cell tower using the second cellular protocol.

According to another embodiment, there is provided a method of converting a cellular protocol of wireless communications at a vehicle. The method includes receiving, at a relay device located in a vehicle, wireless communications sent from a cell tower using a first cellular protocol; converting the wireless communications to a second cellular protocol at the relay device; and transmitting the converted wireless communications to a vehicle telematics unit using the second cellular protocol.

According to yet another embodiment, there is provided a relay device for converting a cellular protocol of wireless communications at a vehicle. The relay device includes a base station transceiver operating according to a first cellular protocol that communicates signals with a vehicle telematics unit; a control unit having a microprocessor and a memory device that translate output from the base station transceiver in the first cellular protocol into a second cellular protocol; and a cellular transceiver operating according to the second cellular protocol that receives the output from the control unit and wirelessly communicates it with a cell tower according to the second cellular protocol.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting another embodiment of a communications system that is capable of utilizing the method disclosed herein

FIG. 3 is a block diagram depicting an exemplary embodiment of a relay device for converting a cellular protocol at a vehicle;

FIG. 4 is a block diagram depicting another exemplary embodiment of a relay device for converting a cellular protocol at a vehicle; and

FIG. 5 is a flow chart depicting an embodiment of a method of converting a cellular protocol of wireless communications at a vehicle.

### DETAILED DESCRIPTION OF THE ILLUSTRATED EMBODIMENT(S)

The system and method described below permits cellular communications from a vehicle telematics unit using one cellular protocol to a wireless carrier system using another cellular protocol that is not compatible with the cellular protocol used by the vehicle telematics unit. As noted above, the vehicle telematics unit may communicate using an older cellular protocol that is no longer serviced by the wireless carrier systems in its area. In that case, a vehicle owner can have a relay device installed at the vehicle such that the relay device can translate the communications generated by the vehicle telematics unit according to the older cellular protocol into content that is readable by the wireless carrier system using another possibly newer cellular protocol. Similarly, cellular communications formatted in the cellular protocol used by the wireless carrier and directed to the vehicle telematics unit can be received at the relay device, converted to the cellular protocol used by the vehicle telematics unit, and then communicated to the vehicle telematics unit. Vehicles having vehicle telematics units that operate using older cellular protocols can then maintain their ability to communicate with wireless carrier systems that no longer support the older cellular protocols.

### Communications System—

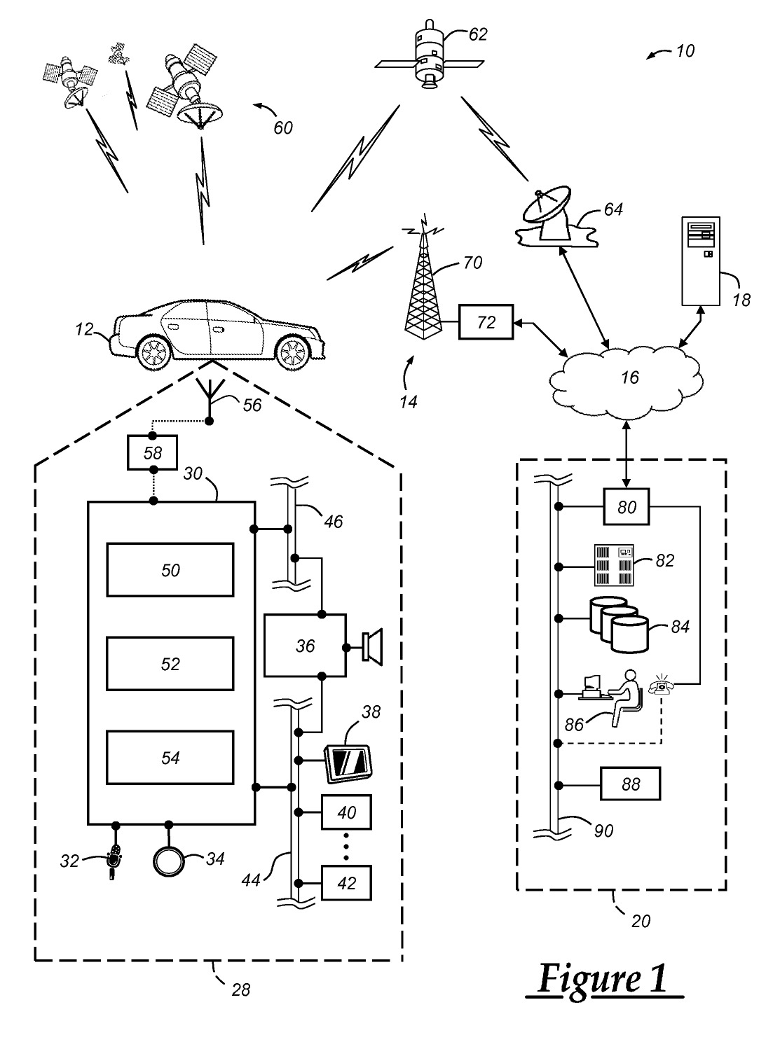

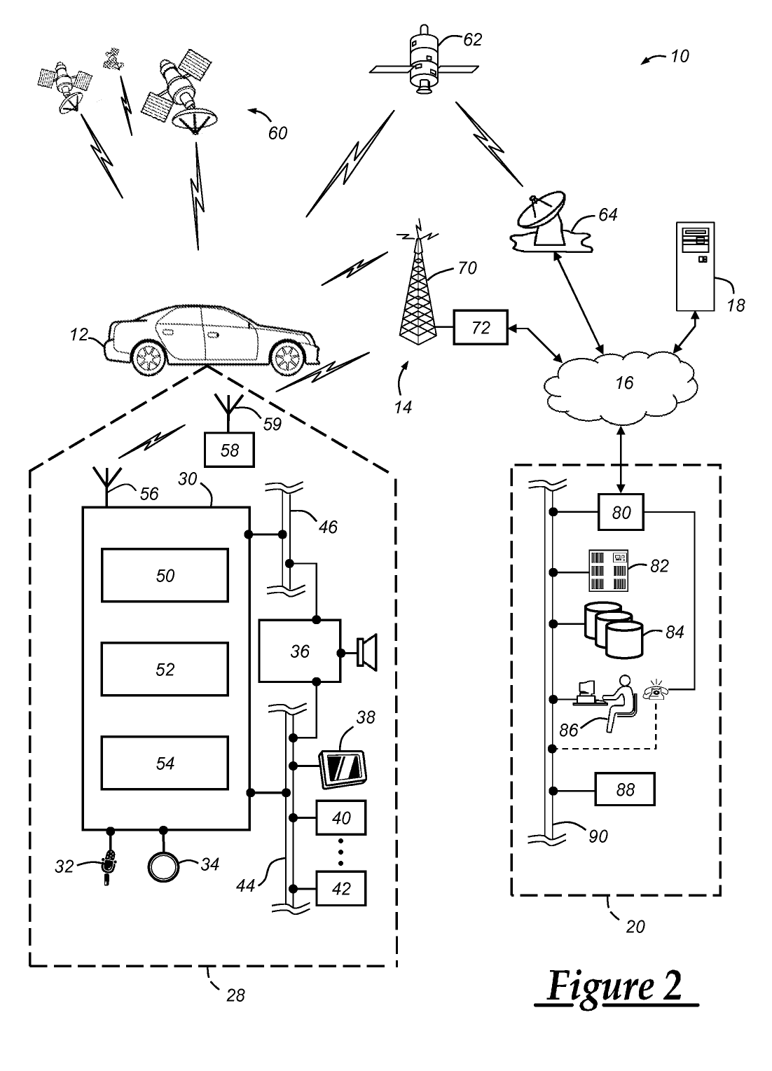

With reference to FIGS. 1 and 2, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. The vehicle telematics unit 30 can also be communicatively linked to a relay device 58 that translates the communications generated by the vehicle telematics unit 30 according to one cellular protocol into content that is readable by the wireless carrier system 14 using another cellular protocol.

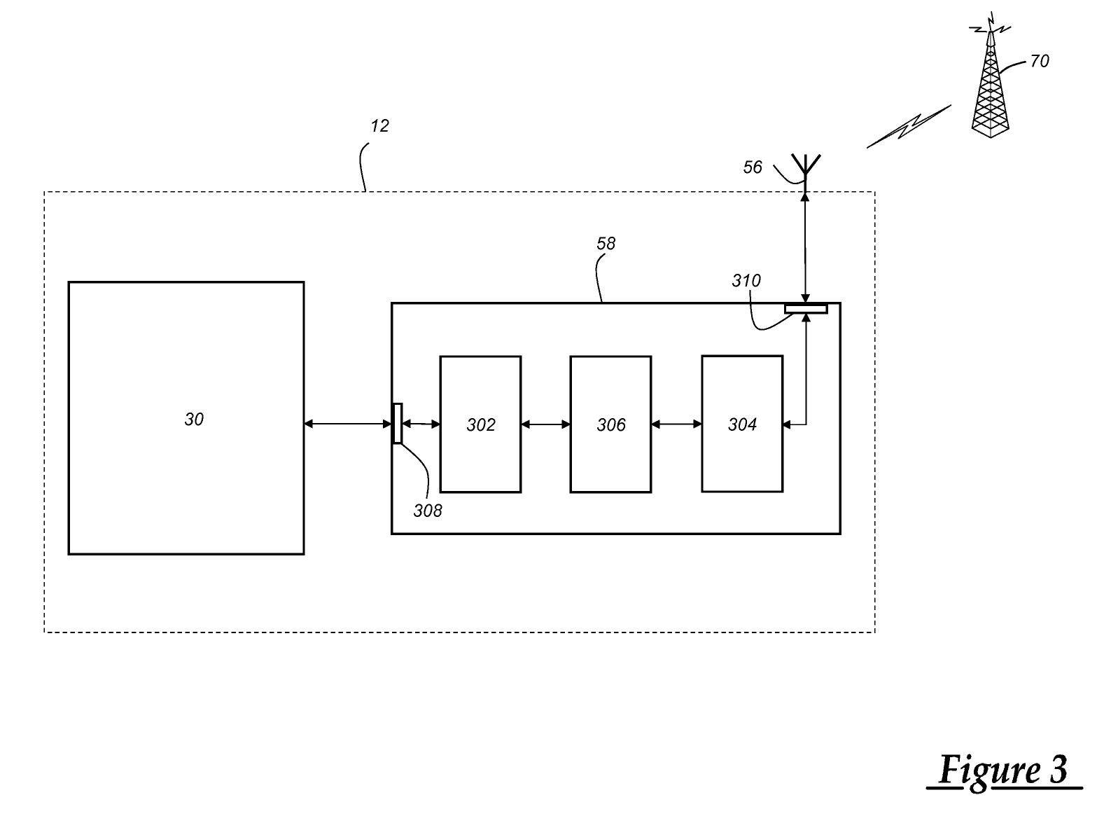

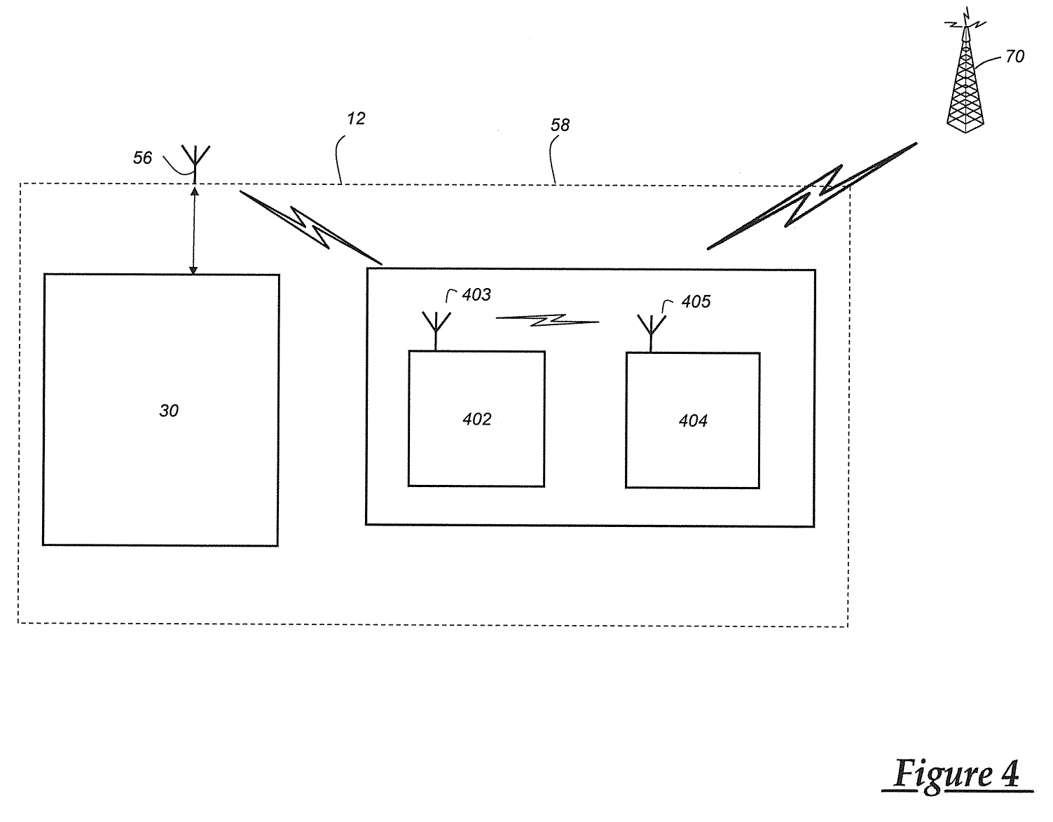

FIGS. 1 and 2 depict the relay device 58 in different configurations. In FIG. 1, the relay device 58 is shown to be hardwired between an output of the vehicle telematics unit 30 and the antenna 56. The hardwired connections are shown as dotted lines reflecting the fact that when the vehicle leaves the factory the antenna 56 will be directly connected to the vehicle telematics unit 30. At that time, the relay device 58 may not be needed because the cellular protocol used by the vehicle telematics unit 30 may also used by the wireless carrier system 14. However, when the wireless carrier system 14 uses a different cellular protocol than the vehicle telematics unit 30, the unit 30 can be detached from the antenna 56 and the relay device 58 can be connected via wire to both the vehicle telematics unit 30 and the antenna 56 in a way that communications flow through the relay device 58. FIG. 2 depicts the relay device 58 as wirelessly receiving output from the vehicle telematics unit 30 and then wirelessly communicating that output to a cell tower 70 using its own dedicated antenna 59. The different implementations of the relay device 58 will be discussed in more detail below with respect to FIGS. 3 and 4.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement a variety of different suitable communications technologies. Some older cellular protocols that can be implemented by the cellular system 14 include for example, analog technologies such as AMPS or 2G CDMA. In contrast, newer cellular protocols can include 3G CDMA (e.g., CDMA2000) or 3G UMTS. As will be appreciated by those skilled in the art, various cell tower/base station/MSC are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements. In addition, the terms “older” or “newer” when used with regard to cellular protocols can indicate the age of the cellular protocols, such that one cellular protocol is an earlier generation of technology relative to another cellular protocol. However, it should also be appreciated that the differences between “older” and “newer” may relate not only to the relative age of the cellular protocols but also or instead indicate that one of the cellular protocols is incompatible with the other. Furthermore, other old/new cellular protocols can be used with the system and method disclosed herein other than those identified above.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

Turning now to FIG. 3, there is shown a block diagram of an exemplary embodiment of a relay device 58 for converting a cellular protocol at the vehicle 12. The relay device 58 includes a base station transceiver 302 that operates according to a first or older cellular protocol and receives one or more communication signals from the vehicle telematics unit 30 according to that protocol. A control unit 306 translates output received according to the older cellular protocol from the base station transceiver 302 into a second or newer cellular protocol. A cellular transceiver 304 operating according to the newer cellular protocol receives the output from the control unit 306 and wirelessly broadcasts it to the cell tower 70 via antenna 56 according to the newer cellular protocol.

One implementation of the relay device 58 can be explained in terms of the vehicle telematics unit 30 communicating according to a 2G CDMA cellular protocol. For purposes of this implementation, the 2G CDMA cellular protocol can be described at the older cellular protocol while a 3G UMTS cellular protocol can be described at the newer cellular protocol. Using these cellular protocols as examples, the relay device 58 can include a base station transceiver 302 communicating using 2G, a cellular transceiver 304 communicating using 3G, and the control unit 306.

The 2G base station transceiver 302 can be implemented as a 2G cellular “femto cell” transceiver having receiving circuitry such as radio frequency (RF), intermediate frequency (IF), and baseband components used to receive and process inbound signals and messages received from the vehicle telematics unit 30 via an RF connector 308. RF connectors can be implemented as a co-axial cable connector, for example, that receives a wired connection from the vehicle telematics unit 30. The 2G base station transceiver 302 can employ conventional signal demodulation techniques for receiving the communication signals from the vehicle telematics unit 30 according to the older cellular protocol. The communications signals and messages may include 2G CDMA voice, text messaging, or data services received on access channels and traffic channels. Additionally, the 2G base station transceiver 302 can provide transmitting circuitry such as RF power amplifiers, RF frequency translators, and baseband components to process and transmit signals and messages sent from the transceiver 302 to the vehicle telematics unit 30 via the RF connector 308. These messages and signals may be related to 2G CDMA voice, text messaging, and data services supported on a pilot channel, a sync channel, a paging channel, or a traffic channel. The 2G base station transceiver can use conventional signal modulation techniques for transmitting the communication signals.

The 3G cellular transceiver 304 can be coupled to the antenna 56 by wire via a second RF connector 310 and communicate voice, text messaging, and data services with the cell tower 70 of one or more wireless carrier systems 14 using the antenna 56. The 3G cellular transceiver 304 can provide receiving circuitry such as RF, IF, and baseband components used to receive and process inbound signals and messages received via the antenna 56 from the cell tower 70 providing service via the new cellular protocol (3G CDMA). The 3G cellular transceiver 304 can use conventional signal demodulation techniques for processing the communication signals. These signals and messages may be related to 3G CDMA voice, text messaging, and data services received on broadcast or dedicated channels. Additionally, the 3G cellular transceiver 304 can include transmitting circuitry, such as RF power amplifiers, RF frequency translators, and baseband components for processing and transmitting outbound signals and messages sent to the cell tower 70 via the antenna 56 in response to commands from the control unit 306. These messages and signals may be related to 3G CDMA voice, text messaging, and data services supported on common and dedicated channels. The 3G cellular transceiver 304 can use conventional signal modulation techniques for transmitting the communication signals.

The control unit 306 includes one or more microprocessors and memory devices that translate signals and messages between the 2G base station transceiver 302 and the 3G cellular transceiver 304. The control unit 306 can automatically manage and control the transmission and reception operations of the 2G base station transceiver 302 and the 3G cellular transceiver 304. The control unit 306 executes computer-readable instructions stored in the memory device using the microprocessor to enable the 2G base station transceiver 302 to communicate with the vehicle telematics unit 30 via the old cellular protocol and the 3G cellular transceiver 304 to communicate with the cell tower 70 via the new cellular protocol. In one example, the control unit 306 can facilitate interworking between 2G CDMA voice services employing an Enhanced Variable Rate Codec (EVRC) at the vehicle telematics unit 30 and 3G UMTS voice services employing Adaptive Multirate Codec (AMR) at the cell tower 70.

FIG. 4 shows an another embodiment of the relay device 58. Here, the relay device 58 can be installed in and receive power from the vehicle 12. The relay device 58 wirelessly communicates information between the vehicle telematics unit 30 and the cell tower 70. To do so, the relay device 58 includes a base station transceiver in the form of a femtocell network 402 and a Wi-Fi hotspot 404. The femtocell network 402 can wirelessly send and receive cellular communications with the vehicle telematics unit 30 using the old cellular protocol. The femtocell network 402 can begin wirelessly communicating with the vehicle telematics unit 30 when cell towers 70 proximate to the vehicle 12 no longer support the older cellular protocol. That is, the vehicle telematics unit 30 may camp on the femtocell network 402 because the unit 30 may not be able to locate a cell tower that provides the old cellular protocol. In one implementation, the femtocell network 402 can detect the absence or presence of cellular communications in a particular band or via an older cellular protocol by the wireless carrier system 14 or cell tower 70. When the femtocell network 402 detects cellular communications in a band according to the older cellular protocol, the femtocell network 402 can stop broadcasting a cellular signal that is receivable by the vehicle telematics unit 30. And when the femtocell network 402 does not detect cellular communications in a band according to the older cellular protocol, the femtocell network 402 can begin broadcasting the cellular signal. The femtocell network 402 can include an antenna 403 that wirelessly links the network 402 not only to the vehicle telematics unit 30 but also to the Wi-Fi hotspot 404 also included within the relay device 58. However, in some implementations antenna 403 can be replaced by one antenna for communicating with the vehicle telematics unit 30 and another antenna for communicating with the Wi-Fi hotspot. The relay device 58 can include the femtocell network 402 and the Wi-Fi hotspot 404 within a single housing or enclosure that is attached to the vehicle 12. The Wi-Fi hotspot 404 can be wirelessly linked to the femtocell network 402 via an antenna 405 that uses a short-range wireless communications link as can be implemented using any one of the protocols described by the IEEE 802.11 standards. It should also be appreciated that in other implementations relay device 58 can be linked by wire rather than antenna 403 and antenna 405.

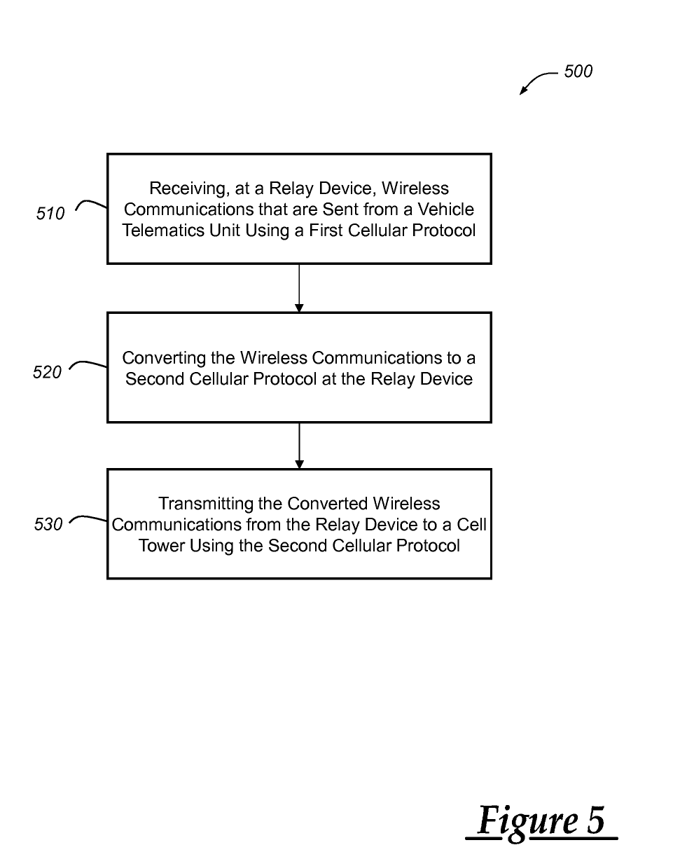

Turning to FIG. 5, there is shown a method 500 of converting a cellular protocol of wireless communications at the vehicle 12. The method 500 begins at step 510 by receiving, at the relay device 58 located in the vehicle 12, wireless communications that are sent from the vehicle telematics unit 30 using a first cellular protocol. The vehicle telematics unit 30 may be configured as a single-mode cellular device such that it can only operate using an older cellular protocol, such as 2G. As discussed above, the wireless carrier system 14 may not be able to communicate using the older cellular protocol but instead only using a second or newer cellular protocol. The relay device 58 can be installed in the vehicle 12 when this occurs. Rather than direct communications between the vehicle telematics unit 30 and the cell tower 70, the relay device 58 can exchange communications with the vehicle telematics unit 30 using the older cellular protocol. That is, the vehicle telematics unit 30 can wirelessly send its communications to the relay device 58 in the format of the older cellular protocol and also receive communications from the relay device 58 in the same cellular protocol. The communications from the vehicle telematics unit 30 can include voice calls, text messages, or data transmissions relating to one or more vehicle functions. The method 500 proceeds to step 510.

At step 520, the wireless communications sent from the vehicle telematics unit 30 using the first or older cellular protocol are received at the relay device 58 and converted to a second or newer cellular protocol. The relay device 58 can convert the received communications into the newer cellular protocol that is compatible with the wireless carrier system 14. In an implementation used with method 500, the relay device 58 includes a base station transceiver in the form of a femtocell network and a Wi-Fi hotspot. The femtocell network can wirelessly send and receive cellular communications with the vehicle telematics unit 30 using the old cellular protocol. The femtocell network can begin wirelessly communicating with the vehicle telematics unit 30 when cell towers 70 proximate to the vehicle 12 no longer support the older cellular protocol. For example, the vehicle telematics unit 30 can search for a cell tower 70 that uses the older cellular protocol but may only find the signal broadcast by the femtocell from the relay device 58. The vehicle telematics unit 30 can then camp on the femtocell when it identifies no other available cellular signal. However, when cell tower 70 is able to communicate using the older cellular protocol, the vehicle telematics unit 30 may camp on the signal from the cell tower 70 as it may be stronger than the signal provided by the femtocell network. In the relay device 58, the signal broadcast by the femtocell network should be strong enough that the vehicle telematics unit 30 will be able to receive it yet weak enough that nearby vehicles and handheld wireless devices will not.

The femtocell network can be wirelessly linked to a Wi-Fi hotspot also included within the relay device 58. The relay device 58 can include the femtocell network and the Wi-Fi hotspot within a single housing or enclosure and the device 58 can then be attached to the vehicle 12 such that the vehicle 12 provides power to the relay device 58. The Wi-Fi hotspot can be wirelessly linked to the femtocell network via a short-range wireless communications link as can be implemented using any one of the protocols described by the IEEE 802.11 standards. The femtocell network can use a Wi-Fi connection resident on the femtocell network to communicate voice or data from the vehicle telematics unit 30 as packetized data to the Wi-Fi hotspot. As an added benefit, the Wi-Fi hotspot can also provide wireless Internet access to wireless devices that are nearby the vehicle 12 and able to communicate via short-range wireless protocols. The method 500 proceeds to step 520.

At step 530, the converted wireless communications are transmitted from the relay device 58 to the cell tower 70 using the second or newer cellular protocol. The Wi-Fi hotspot of the relay device 58 can be configured to communicate with the cell tower 70 using the newer cellular protocol. Thus, the Wi-Fi hotspot can establish a wireless communications link with the cell tower 70 and transmit the wireless communications to the cell tower 70 using the newer cellular protocol such that the communications are received and understood by the wireless carrier system 14. It should be appreciated that steps 310-330 can be reversed to receive wireless communications sent to the vehicle telematics unit 30 according to the second or newer cellular protocol. In that case, the relay device 58 can receive the wireless communications sent via the newer cellular protocol, convert the wireless communications from the newer cellular protocol to the first or older cellular protocol at the relay device 58, and transmit the converted wireless communications to the vehicle telematics unit 30 according to the older cellular protocol. The method 500 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of converting a cellular protocol of wireless communications at a vehicle, comprising the steps of:
(a) receiving, at a relay device located in a vehicle, wireless communications that are sent from a vehicle telematics unit using a first cellular protocol;
(b) converting the wireless communications to a second cellular protocol at the relay device; and
(c) transmitting the converted wireless communications from the relay device to a cell tower using the second cellular protocol.

2. The method of claim 1, wherein the relay device further comprises a base station transceiver and a Wi-Fi hotspot.

3. The method of claim 2, wherein the base station transceiver further comprises a femtocell network.

4. The method of claim 3, further comprising the step of communicating between the femtocell network and the Wi-Fi hotspot via a short-range wireless protocol.

5. The method of claim 1, wherein the first cellular protocol is older than the second cellular protocol.

6. A method of converting a cellular protocol of wireless communications at a vehicle, comprising the steps of:
(a) receiving, at a relay device located in a vehicle, wireless communications sent from a cell tower using a first cellular protocol;
(b) converting the wireless communications to a second cellular protocol at the relay device; and
(c) transmitting the converted wireless communications to a vehicle telematics unit using the second cellular protocol.

7. The method of claim 6, wherein the relay device further comprises a base station transceiver and a Wi-Fi hotspot.

8. The method of claim 7, wherein the base station transceiver further comprises a femtocell network.

9. The method of claim 8, further comprising the step of communicating between the femtocell network and the Wi-Fi hotspot via a short-range wireless protocol.

10. The method of claim 6, wherein the first cellular protocol is older than the second cellular protocol.

11. A relay device for converting a cellular protocol of wireless communications at a vehicle, comprising:
a base station transceiver operating according to a first cellular protocol that communicates signals with a vehicle telematics unit;
a control unit having a microprocessor and a memory device that translate output from the base station transceiver in the first cellular protocol into a second cellular protocol; and
a cellular transceiver operating according to the second cellular protocol that receives the output from the control unit and wirelessly communicates it with a cell tower according to the second cellular protocol.

12. The relay device of claim 11, wherein the base station transceiver further comprises a femtocell network.

13. The relay device of claim 11, wherein the cellular transceiver further comprises a Wi-Fi hotspot.

14. The relay device of claim 11, further comprising a radio frequency (RF) connector that receives wireless communications from a vehicle telematics unit.
